(19) United States
(12) Patent Application Publication
(10) Pub. No.: US 2025/0364670 A1
(43) Pub. Date: Nov. 27, 2025

(54) A CYLINDRICAL SECONDARY CELL

(71) Applicant: Northvolt AB, Stockholm (SE)

(72) Inventors: Tetsuya MAKINO, Solna (SE); Kenya SHATANI, Stockholm (SE)

(21) Appl. No.: 18/872,415

(22) PCT Filed: Jun. 13, 2023
(86) PCT No.: PCT/EP2023/065751

§ 371 Date: Dec. 6, 2024

(30) Foreign Application Priority Data
Jun. 14, 2022 (SE) 2250716-4

(51) Int. Cl. H01M 50/342; H01M 50/107; H01M 50/533; H01M 50/55; H01M 50/559; H01M 50/586; H01M 50/59

(52) U.S. Cl. CPC H01M 50/3425; H01M 50/107; H01M 50/533; H01M 50/55; H01M 50/559; H01M 50/586; H01M 50/59; H01M 2200/20

(57) ABSTRACT

A cylindrical secondary cell comprising a cylindrical housing comprising a first end side (2a) and an opposite second end side, and a first terminal (4a) comprised in a first portion of the first end side, and a second terminal (4b) comprised in a second portion of the first end side, wherein the first end side comprises a first breakable portion (10) configured to provide a first opening in the first end side if the pressure inside the cylindrical housing reaches a first threshold value.

### TECHNICAL FIELD

The present disclosure generally pertains to cylindrical secondary cells, and more particularly to cylindrical secondary cells having an end with a breakable portion.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

A rechargeable battery, often referred to as a secondary battery, typically comprises one or more secondary cells electrically connected to each other. As the demand for rechargeable batteries increases, more and more focus is being placed on production speed. To achieve an effective production of safe rechargeable batteries, the design of the cells and the batteries can be optimized. Another aspect is that the rechargeable batteries must be safe to use. Therefore, some rechargeable batteries have at least one vent for releasing gas and/or other ejecta when the pressure inside the batteries rises above an allowed level.

However, current designs of such vents do not permit production at sufficient speeds. Furthermore, such vents can cause gas and/or other ejecta to be released in undesired directions, and little flexibility is provided when it comes to how and where the gas and/or other ejecta is released.

### SUMMARY

It is in view of the above considerations and others that the embodiments of the present invention have been made. The present disclosure aims at providing secondary cells that comprise an end with a breakable portion that breaks when the pressure inside the batteries rises above an allowed level to provide an opening allowing gas and/or other ejecta to be released. The design of the secondary cell disclosed herein can be adapted to different use cases and optimised to keep up with cell development.

According to an aspect, the present disclosure provides a cylindrical secondary cell comprising a cylindrical housing comprising a first end side and an opposite second end side, and a first terminal comprised in a first portion of the first end side, and a second terminal comprised in a second portion of the first end side, wherein the first end side comprises a first breakable portion configured to provide a first opening in the first end side if the pressure inside the cylindrical housing reaches a first threshold value.

Optionally, the first breakable portion is comprised in the second portion of the first end side. Optionally, the first portion and the second portion are concentric, and the second terminal is in electrical contact with a housing sidewall that extends from the first end side to the second end side. Optionally, the first portion is circular in shape and the second portion is annular in shape. Optionally, the first terminal is provided on a structure, such as a rivet, and the structure is spaced from the first breakable portion. Optionally, the first terminal is a positive terminal and the second terminal is a negative terminal.

Optionally, the cylindrical secondary cell further comprises a first current collecting plate arranged at a first end of the cylindrical housing, an insulation layer disposed between the first current collecting plate and the second terminal, wherein the first terminal is arranged in direct electrical contact with the first current collecting plate. Optionally, the first current collecting plate comprises at least one aperture. Optionally, the first current collecting plate and/or the insulation layer are spaced from the first breakable portion. Optionally, the first breakable portion is aligned with the one or more apertures.

Optionally, the second end side comprises a second breakable portion configured to provide a second opening in the second end side if the pressure inside the cylindrical housing reaches a second threshold value. Optionally, the first and second thresholds are different. Optionally, the cylindrical secondary cell further comprises a second current collecting plate arranged at a second end of the cylindrical housing, and wherein the second terminal is arranged in electrical contact with the second current collecting plate via the cylindrical housing.

Optionally, the opening is in fluid communication with an interior of the cylindrical housing such that gas is able to flow out of the cylindrical housing via the opening. Optionally, the breakable portion is a perforated or scored/notched portion of the housing or a portion of the housing having a reduced thickness. Optionally, the breakable portion is annular in shape. Optionally, the breakable portion comprises a plurality of breakable portions each configured to provide respective openings. Optionally, the each of the plurality of breakable portions has the same form.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which

FIG. 1a shows a cylindrical secondary cell in a perspective view,

FIG. 1b shows a first end of the cylindrical secondary cell in cross section,

FIG. 2a shows the cylindrical secondary cell in a perspective view,

FIG. 2b shows the first end of the cylindrical secondary cell in cross section,

FIG. 3a shows a first end of a cylindrical secondary cell in cross section,

FIG. 3b shows a current collecting plate in a plan view,

FIG. 3c shows the first end of the cylindrical secondary cell in cross section,

FIG. 4a shows a cylindrical secondary cell in a perspective view,

FIG. 4b shows a second end of the cylindrical secondary cell in cross section,

FIG. 5a shows the cylindrical secondary cell in a perspective view,

FIG. 5b shows the second end of the cylindrical secondary cell in cross section, and

FIGS. 6a-f show first ends of a number of cylindrical secondary cells in a plan view.

### DETAILED DESCRIPTION

Embodiments of the present disclosure will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

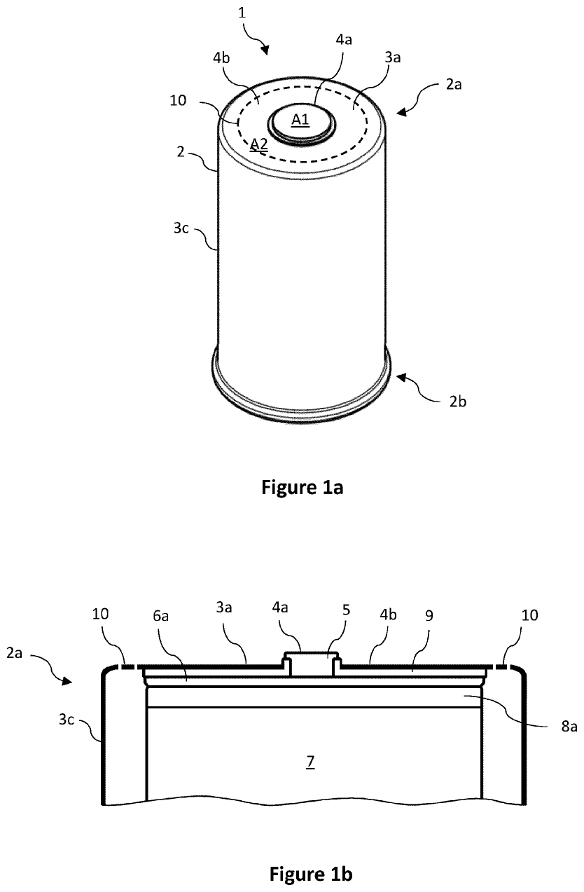

FIG. 1a shows a perspective view of a cylindrical secondary cell 1 (hereinafter referred to as cell). In the exemplified embodiment, the cell is circular cylindrical and the height (along a longitudinal axis) is approximately 140 percent of the diameter. The cell 1 comprises a cylindrical housing 2 having a first end 2a and an opposite second end 2b.

The first end 2a comprises a first end side 3a and the second end 2b comprises a second end side 3b. A sidewall 3c extends between the two end sides 3a, 3b. In the exemplified embodiment, the end sides 3a, 3b are circular. The first end side 3a may be formed in one piece with the cylindrical enclosure 2 (as illustrated in FIG. 1) and the second end side 3b may be formed by a separate second enclosure end lid (not shown), or vice versa. Alternatively, both end sides 3a, 3b may be formed by respective lids.

The first end side 3a comprises a first contact area A1 and a second contact area A2. The contact areas A1, A2 are located on the surface of the first end side 3a of the cylindrical housing 2. A first terminal 4a is provided by the first contact area A1. A second terminal 4b is provided by the second contact area A2. Typically, to form a battery a number of cells 1 are arranged next to one another. Such a battery may be an electric vehicle battery. The respective terminals 4a, 4b of the cells 1 may be electrically connected to one another and to main battery terminals.

As is shown, the first and second contact areas A1, A2 may be concentric, such that the second contact area A2 surrounds the first contact area A1. In the present example, the first contact area A1 is circular and the second contact area A2 is annular.

The first terminal 4a and the second terminal 4b are both arranged on the first end side 3a. The cell 1 may comprise an electrical isolator arranged between the first and second contact areas A1, A2 to form an isolating area on the first end side 3a between the first and second terminals 4a, 4b.

The first, or inner, terminal 4a may be a positive terminal and thus the first, or inner, contact area A1 may be a positive terminal contact area. The second, or outer, terminal 4b may be a negative terminal and thus the second, or outer, contact area A2 may be a negative terminal contact area. As such, the cell 1 has both a positive terminal 4a and a negative terminal 4b at one end (the first end 2b) of the cell 1.

The first terminal 4a is formed by a terminal element 5 that protrudes through the first end side 3a (shown in FIG. 1b). More precisely, the first terminal 4a is formed by the top surface of the terminal element 5. The first end side 3a may comprise a central terminal through-hole (not shown) for the terminal element 5. The terminal element 5 may have the shape of a rivet with a head portion, or so-called factory rivet head, and a shaft portion, or rivet shaft.

In the present embodiment, the second terminal 4b is formed by the first end side 3a cylindrical housing 2. More precisely, the second terminal 4b is formed by the top surface of the first end side 3a. In the present embodiment, the first end side 3a is provided in one piece with the sidewall 3c. The second terminal 4b is therefore electrically connected to the cylindrical housing 2, including the sidewall 3c. Thus, the entire cylindrical housing 2 may be a negative terminal.

A cylindrical secondary cell 1 having both terminals 4a, 4b at one end may bring advantages as regards electrically connecting the cell 1 to a load. Conductors electrically connecting the terminals to the load may be positioned on the same end of the cell 1 (the first end 2a). The opposite end of the cell 1 (the second end 2b) may be dedicated to electrolyte filling. This disclosure does however not exclude filling of electrolyte at the first end 2a.

FIG. 1b shows the first end 2a of the cylindrical secondary cell 1 in cross section. As illustrated in FIG. 1b, a current collecting plate 6a is arranged at the first end 2a of the cylindrical housing 2. The current collecting plate 6a may be disc-shaped element. The current collecting plate 6a is in direct electrical contact with the first terminal 4a, more precisely via physical contact with the terminal element 5. The current collecting plate 6a is in direct electrical contact on an opposite side with an electrode roll 7 (also known as a jelly roll). As known in the art, the electrode roll 7 may comprise first and second conductive sheets providing an anode and a cathode respectively, with separating means disposed between, and an electrolyte solution. A contact portion 8a of the first conductive sheet is in contact with the current collecting plate 6a. The current collecting plate 6a may be attached, for example welded, for example laser welded, to the contact portion 8a. An insulation layer 9 may be present between the current collecting plate 6a and the second portion (A2) of the first end side 3a comprising the second terminal 4b, such that electrical contact between the second terminal 4b and the current collecting plate 6a is prevented.

During operation of the cell 1, an overpressure may be generated within the cell 1, for example upon malfunction of the cell 1 or of the load connected to the cell 1, for example thermal runaway. Such a malfunction may require a release of gas and/or other ejecta out of the cell 1 in order to relieve the pressure. Furthermore, it may be advantageous to direct the released gas and/or other ejecta away from the terminals 4a, 4b.

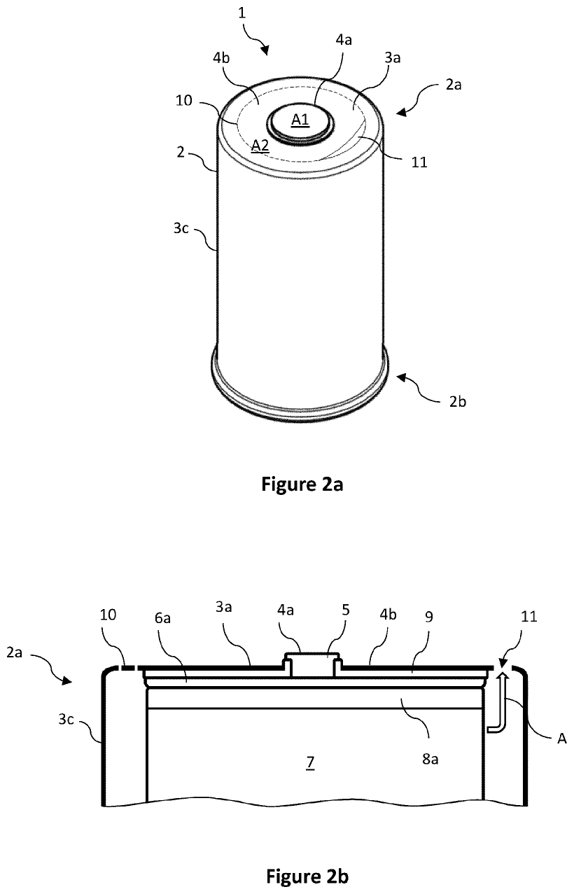

To this end, the cylindrical secondary cell 1 is provided with a breakable portion 10 configured to break if the pressure inside the cylindrical housing 2 reaches a threshold value. When the breakable portion 10 breaks, an opening is provided through which gas and/or other ejecta can be released out of the cell 1, as explained in relation to FIGS. 2a and 2b.

The breakable portion 10 is provided in the first end side 3a of the cylindrical housing 2. In particular, the breakable portion 10 is provided in the second contact area A2 of the first end side 3a comprising the second terminal 4b. The breakable portion 10 may be continuous and/or annular in shape, as shown in FIG. 1a. The breakable portion 10 is spaced from the terminal element 5, the current collecting plate 6a, and/or the insulation layer 9, as shown in FIG. 1b.

The breakable portion 10 may be a weakened portion of the housing 2 such that it breaks before other parts of the cell 1. For example, the breakable portion 10 may be perforated, scored, notched, or have reduced thickness relative to the rest of the housing 2. Other methods of providing a suitable breakable portion 10 will be readily envisaged by the person skilled in the art.

Turning to FIGS. 2a and 2b, the cell 1 is shown after the pressure inside the cylindrical housing 2 has reached the threshold value. FIG. 2a shows a perspective view of the cylindrical secondary cell 1, whilst FIG. 2b shows the first end 2a of the cylindrical secondary cell 1 in cross section. The breakable portion 10 has broken to provide an opening 11 in the first end side 3a. The opening 11 is shown on one side of the first end side 3a, but it will be appreciated that several openings could be formed along the length of the breakable portion 10, or indeed the entire breakable portion 10 could break. In the instance that the entire breakable portion 10 breaks, a disconnection of power may result.

As shown in FIG. 2b, the opening 11 is in fluid communication with the interior of the cylindrical housing 2 such that gas and/or other ejecta is able to flow out of the cylindrical housing 2 via the first opening 11 as indicated by flow path A. As the breakable portion 10 is spaced from the terminal element 5, the current collecting plate 6a, and the insulation layer 9, the flow of gas and/or other ejecta from the interior to the exterior of the housing 2 is not impeded by these elements. A cylindrical secondary cell that is configured in this way allows gas and/or other ejecta to be released from the cell through a first end side in case of an overpressure inside the cell.

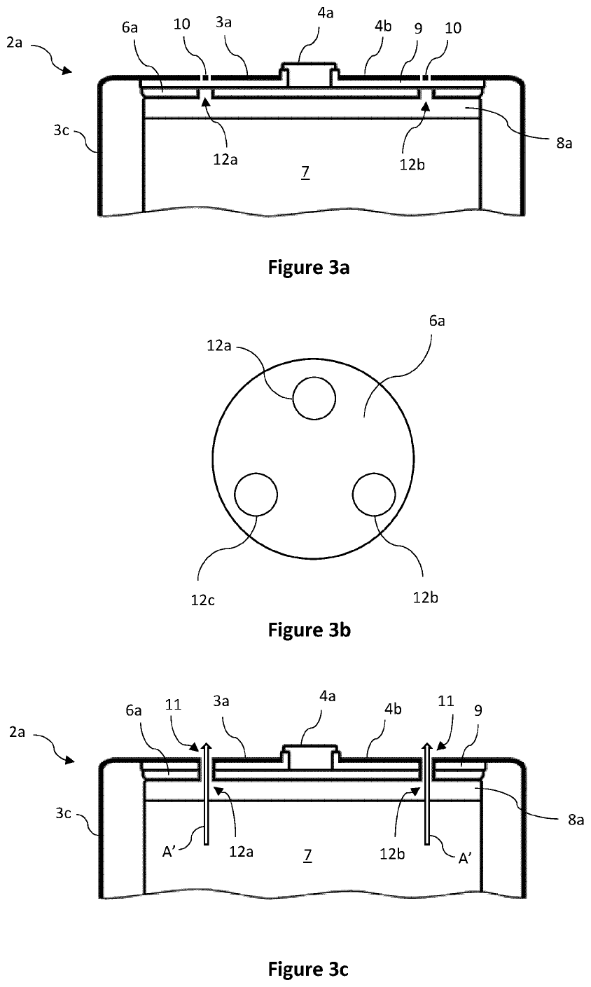

FIGS. 3a to 3c show an alternative structure for a cylindrical secondary cell 1. FIG. 3a shows the first end 2a of the cylindrical secondary cell 1 in cross section. FIG. 3b shows a plan view of the current collecting plate 6a. FIG. 3a shows the first end 2a of the cylindrical secondary cell 1 in cross section after the pressure inside the cylindrical housing 2 has reached the threshold value.

As shown in FIGS. 3a and 3b, the current collecting plate 6a comprises one or more apertures 12a-c. The apertures 12a-c extend through the current collecting plate 6a allowing gas and/or other ejecta to flow through the plate 6a. The apertures 12a-c are shown as being circular, but it will be appreciated that any suitable form of aperture may be provided, for example as described in Swedish application number 2150504-5. Whilst three apertures 12a-c are shown, it will be appreciated that any suitable number of apertures may be provided, for example as also described in Swedish application number 2150504-5. The first breakable portion 1 may be aligned with the one or more apertures 12a-c, but remains spaced from the terminal element 5.

As shown in FIG. 3c, when the pressure inside the cylindrical housing 2 has reached the threshold value, the breakable portion 10 breaks to provide one or more openings 11. The pressure inside the cylindrical housing 2 is sufficient that gas and/or other ejecta is able to remove or blow through the insulation layer 9 as it flows out of the cylindrical housing 2. As such, the opening 11 is in fluid communication with the interior of the cylindrical housing 2 via the apertures 12a-c. Therefore, gas and/or other ejecta is able to flow out of the cylindrical housing 2 via the apertures 12a-c and the opening 11 as indicated by flow path A′. As the breakable portion 10 is spaced from the terminal element 5, the flow of gas and/or other ejecta from the interior to the exterior of the housing 2 is not impeded by the terminal element 5. A cylindrical secondary cell that is configured in this way allows gas and/or other ejecta to be released from the cell through a first end side in case of an overpressure inside the cell. The apertures provide a shorter path for gas and/or other ejecta flowing out of the cylindrical housing 2.

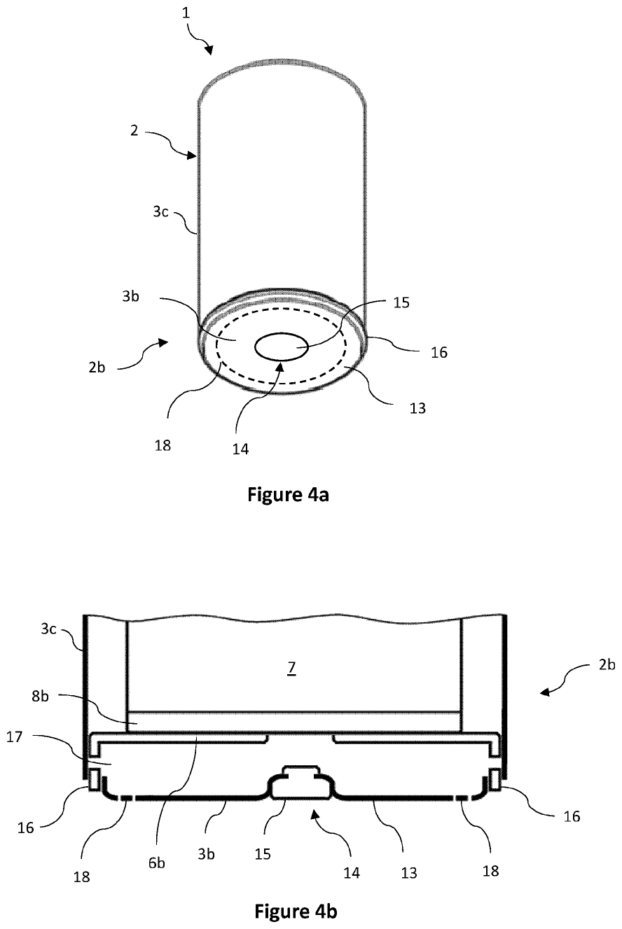

FIGS. 4a and 4b show the second end 2b of the cell 1. FIG. 4a shows a perspective view of the cylindrical secondary cell 1, whilst FIG. 4b shows the second end 2b of the cylindrical secondary cell 1 in cross section. In this embodiment, the second end is provided by a lid 13 comprising a filling opening 14 for filling the cylindrical enclosure 2 with electrolyte. The lid 13 may be a disc-shaped element of a dimension adapted to the cylindrical enclosure 2. After filling, the filling opening 14 is closed by a blind rivet 15. Alternatively, the filling opening 14 may be closed by a ball welded to the rim of the filling opening 14. In this embodiment, the lid 13 is electrically insulated from the cylindrical enclosure 2 by a gasket 16 that is arranged between the lid 13 and the inner wall surface of the cylindrical enclosure 2.

As is shown in FIG. 4b, a current collecting plate 6b is arranged at the second end 2b of the cylindrical housing 2. The current collecting plate 6b may be disc-shaped element. The current collecting plate 6b may be attached to the cylindrical enclosure 2 at a distance from the second end side 3b, i.e. at a distance along the axial direction of the cell 1. Thereby, there is room for the lid 13 to be attached to the second end 2b such that, after assembly of the cell 1, the current collecting plate 6b may be positioned between the lid 13 and the electrode roll 7. The current collecting plate 6b is in direct electrical with a contact portion 8b of the second conductive sheet of the electrode roll 7. The current collecting plate 6b may be attached, for example welded, for example laser welded, to the contact portion 8b. The current collecting plate 6b may be attached to the cylindrical enclosure 2 at a sufficient distance from the second end side 3b such that an electrolyte flow chamber 17 is created between the current collecting plate 6b and the lid 13.

As is further illustrated, the current collecting plate 6b is in direct electrical contact with the cylindrical enclosure 2. The current collecting plate 6b may be attached, for example welded, to the cylindrical enclosure 2. The current collecting plate 6b may be welded to the cylindrical enclosure 2 for example by laser welding, ultrasonic seam welding, ultrasonic torsional welding or resistance welding. In this way, the sidewall 3c of the housing 2, and therefore the first end side 3a and the second terminal 4b, are in electrical contact with the current collecting plate 6b.

As it may be advantageous to use the same metal throughout a current path, especially within a battery that contains an electrolyte, the current collecting plate 6b and the cylindrical enclosure 2 are preferably of the same metal. The cylindrical enclosure 2 may thus be made from copper or steel. This brings the advantage that the cylindrical enclosure 2 may be designed with a thin wall, as compared to a cylindrical enclosure of aluminium, as copper and steel have higher tensile strengths than aluminium. Another advantage is that copper and steel both have higher melting points than aluminium, which may increase the safety of the cell 1. The current collecting plate 6b may be attached to the cylindrical enclosure 2 by plastic deformation of the cylindrical enclosure 2, which may also deform the current collecting plate 6b, and/or by welding, for example by ultrasonic torsional welding. Welding, in both embodiments, may be done from either the inside of the cylindrical enclosure or the outside.

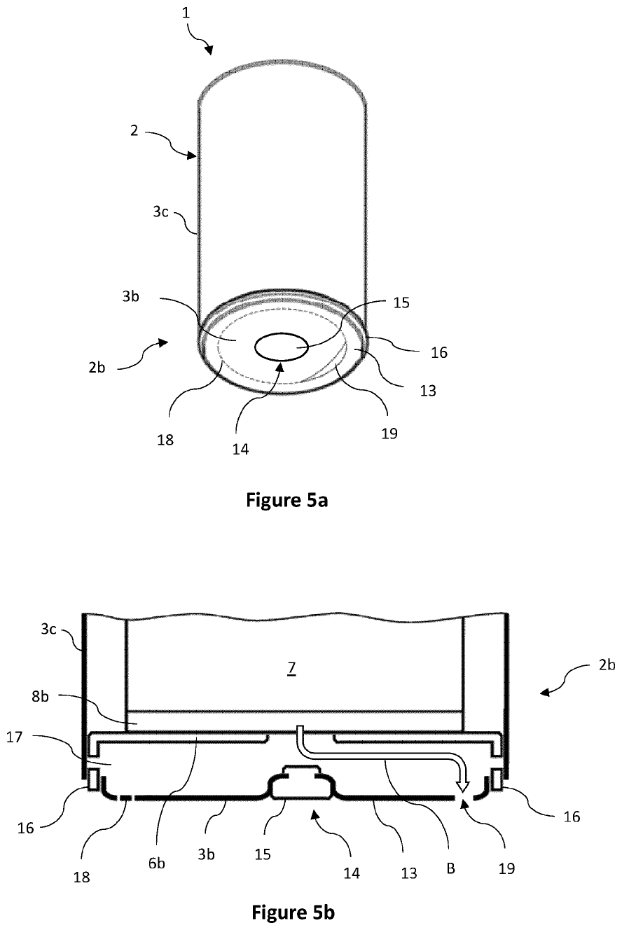

In this embodiment, the second end side 3b is also provided with a breakable portion 18 configured to break if the pressure inside the cylindrical housing 2 reaches a threshold value. When the breakable portion 18 breaks, an opening is provided through which gas and/or other ejecta can be released out of the cell 1, as explained in relation to FIGS. 5a and 5b.

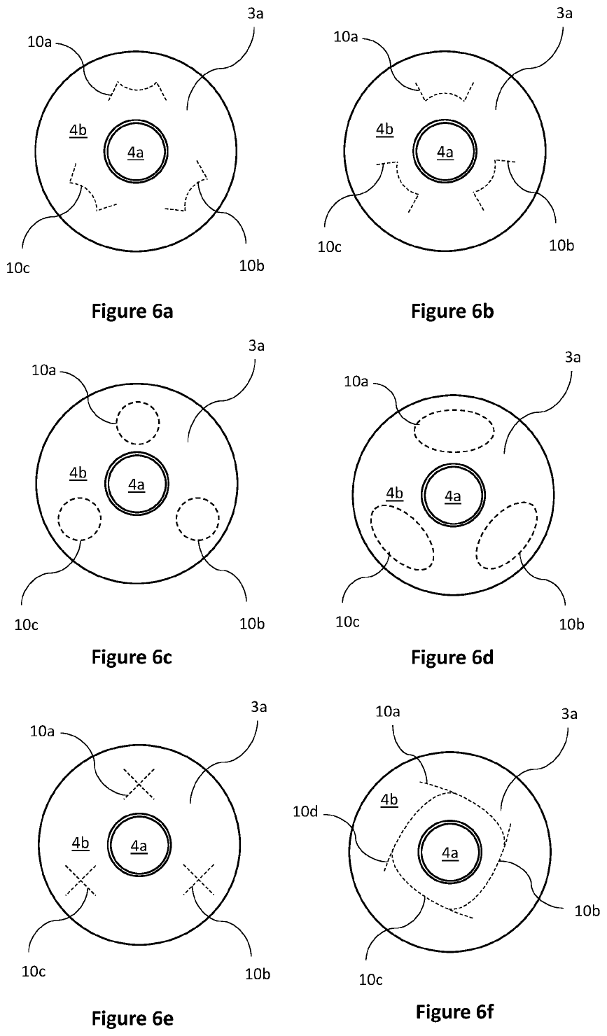

The breakable portion 18 may be continuous and/or annular in shape, as shown in FIG. 4a. The breakable portion 18 may be a weakened portion of the housing 2 such that it breaks before other parts of the cell 1. For example, the breakable portion 18 may be perforated, scored, notched, or have reduced thickness relative to the rest of the housing 2. The breakable portion 18 may have the same shape as the breakable portion 10 as described below in connection with FIGS. 6a-f. Other methods of providing a suitable breakable portion 18 will be readily envisaged by the person skilled in the art.

Turning to FIGS. 5a and 5b, the cell 1 is shown after the pressure inside the cylindrical housing 2 has reached the threshold value. FIG. 5a shows a perspective view of the cylindrical secondary cell 1, whilst FIG. 5b shows the second end 2b of the cylindrical secondary cell 1 in cross section. The breakable portion 18 has broken to provide an opening 19 in the second end side 3b. The opening 19 is shown on one side of the second end side 3b, but it will be appreciated that several openings could be formed along the length of the breakable portion 18, or indeed the entire breakable portion 18 could break.

As shown in FIG. 5b, the opening 19 is in fluid communication with the interior of the cylindrical housing 2 such that gas and/or other ejecta is able to flow out of the cylindrical housing 2 via the first opening 19 as indicated by flow path B. As the electrolyte flow chamber 17 is formed between the current collecting plate 6b and the lid 13, the flow of gas and/or other ejecta from the interior to the exterior of the housing 2 is not impeded.

A cylindrical secondary cell that is configured in this way allows gas and/or other ejecta to be released from the cell through a second end side in case of an overpressure inside the cell, whilst directing the gas and/or other ejecta away from the conductive elements of the cell.

As discussed above, the breakable portions 10, 18 are configured to break when the pressure inside the cylindrical housing 2 reaches a threshold value. In some embodiments, the breakable portions 10, 18 are configured to break at the same threshold pressure. In other embodiments, the breakable portions 10, 18 are configured to break at different threshold pressures. For example, a number of cells 1 may be positioned at a low position in an electric vehicle. The cells may be arranged with the first ends 2a directed upwards and the second ends 2b directed downwards. Upon malfunction, for example resulting from a faulty electric vehicle charger or a faulty cell, a release of gas and/or other ejecta from the second ends 2b will be advantageously directed downwards towards the ground beneath the vehicle. In this case, the threshold pressure at which the breakable portion 18 is configured to break may be lower than the threshold pressure at which the breakable portion 10 is configured to break. If it were desired that gas and/or other ejecta be released from the first ends 2a, the threshold pressure at which the breakable portion 18 is configured to break may be higher than the threshold pressure at which the breakable portion 10 is configured to break. Other configurations of the thresholds will be readily envisaged dependent on different use cases. Providing breakable portions with different thresholds therefore increases the flexibility of use of the cell, as it is adaptable to different use cases.

FIGS. 6a-f show different embodiments of the breakable portion 10 at the first end 2a of the cell 1. In each case, the breakable portion 10 comprises a plurality of breakable portions 10a-c. Each breakable portion 10a-c is configured to provide a respective opening 11 in the first end side 3a of the housing 2 when the pressure inside the cylindrical housing 2 reaches a threshold value. Different secondary cells may have different chemistries, and different chemistries will give different pressures in case of a malfunction such as thermal runaway. Therefore, different configurations may be appropriate for these different chemistries.

FIG. 6a shows a first embodiment where the breakable portion 10 comprises a plurality of breakable portions 10a-c. In this embodiment, the breakable portions 10a-c each have a three-sided form that provides a flap-type portion of the first end side 3a. When the pressure inside the cylindrical housing 2 reaches a threshold value, the three sides of the breakable portions 10a-c may break, whereas a remaining part will stay attached. As such, the remaining part acts as a hinge for a flap-type portion. The flap-type portion of the first end side 3a will lift and provide an opening facing generally outwards, away from the first terminal 4a. This configuration ensures that gas and/or other ejecta flowing out from the interior of the housing 2 is directed away from the first terminal 4a.

FIG. 6b shows a second embodiment that is similar to that of FIG. 6a, except that the breakable portions 10a-c are arranged such that, when the pressure inside the cylindrical housing 2 reaches a threshold value, the flap-type portion of the first end side 3a will lift and provide an opening facing generally inwards, towards the first terminal 4a.

FIG. 6c shows a third embodiment where the breakable portion 10 comprises a plurality of breakable portions 10a-c. In this embodiment, the breakable portions 10a-c each have a circular form. FIG. 6d shows a fourth embodiment that is similar to that of FIG. 6a, except that the breakable portions 10a-c each have an elliptical form.

FIG. 6e shows a fifth embodiment where the breakable portion 10 comprises a plurality of breakable portions 10a-c. In this embodiment, the breakable portions 10a-c each have an X-shaped form.

FIG. 6f shows a sixth embodiment where the breakable portion 10 comprises a plurality of breakable portions 10a-c. In this embodiment, the breakable portions 10a-d each have a curvilinear form, and extend in a generally circumferential direction. Each breakable portion 10a-d contacts an adjacent breakable portion such that an enclosed portion of the second contact area A2 is formed. Each breakable portion 10a-d has a tail that extends outside of the enclosed portion of the second contact area A2, for example, around 20% of the length of each breakable portion may be outside of the enclosed portion of the second contact area A2. In the instance that all the breakable portions 10a-d break, a disconnection of power may result.

Whilst three breakable portions 10a-c are shown in each of FIGS. 6a-f, it will be appreciated that two, four, or any other suitable number of breakable portions may also be provided. In some embodiments, each of the breakable portions 10a-c is aligned with a respective one of the apertures 12a-c. Whilst the breakable portions 10a-c in each of FIGS. 6a-f have the same form, it will be appreciated that individual breakable portions may have different forms. For example, a cell 1 may be provided with a first breakable portion 10a having a flap-type form, a second breakable portion 10b having a circular form, and a third breakable portion 10c having an X-shaped form. In embodiments where the current collecting plate 6a comprises at least one aperture 12a-c, at least one of the breakable portions 10a-c may be aligned with one of the apertures 12a-c.

It will also be appreciated that the concepts described in relation to FIGS. 6a-f could equally apply to the breakable portion 18 at the second end 2b of the cell 1. In some embodiments, breakable portions provided on the first and second end sides 3a, 3b of the cell 1 may all have the same form. In some embodiments, breakable portions 10a-c having a first form may be provided on the first end side 3a of the cell 1, whilst breakable portions having a second form may be provided on the second end side 3b of the cell 1. In some embodiments, breakable portions provided on the first and second end sides 3a, 3b of the cell 1 may all have different forms.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, the cylindrical secondary cell is shown as being circular cylindrical. However, other cross-sections, such as a rounded square or a rounded rectangular cross-section, are also conceivable.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1. A cylindrical secondary cell (1) comprising
a cylindrical housing (2) comprising a first end side (3a) and an opposite second end side (3b), and
a first terminal (4a) comprised in a first portion (A1) of the first end side (3a), and
a second terminal (4b) comprised in a second portion (A2) of the first end side (3a),
wherein the first end side (3a) comprises a first breakable portion (10) configured to provide a first opening (11) in the first end side (3a) if the pressure inside the cylindrical housing (2) reaches a first threshold value.

2. The cylindrical secondary cell (1) of claim 1, wherein the first breakable portion (10) is comprised in the second portion (A2) of the first end side (3a).

3. The cylindrical secondary cell (1) of claim 1, wherein the first portion (A1) and the second portion (A2) are concentric, and the second terminal (4b) is in electrical contact with a housing sidewall (3c) that extends from the first end side (3a) to the second end side (3b).

4. The cylindrical secondary cell (1) of claim 3, wherein the first portion (A1) is circular in shape and the second portion (A2) is annular in shape.

5. The cylindrical secondary cell (1) of claim 1, wherein the first terminal (4a) is provided on a structure (5), such as a rivet, and the structure (5) is spaced from the first breakable portion (10).

6. The cylindrical secondary cell (1) of claim 1, wherein the first terminal (4a) is a positive terminal and the second terminal (4b) is a negative terminal.

7. The cylindrical secondary cell (1) of claim 1, further comprising:
a first current collecting plate (6a) arranged at a first end (2a) of the cylindrical housing (2), and
an insulation layer (9) disposed between the first current collecting plate (6a) and the second terminal (4b),
wherein:
the first terminal (4a) is arranged in direct electrical contact with the first current collecting plate (6a).

8. The cylindrical secondary cell (1) of claim 7, wherein the first current collecting plate (6a) comprises at least one aperture (12a-c).

9. The cylindrical secondary cell (1) of claim 7, wherein the first current collecting plate (6a) and/or the insulation layer (9) are spaced from the first breakable portion (10).

10. The cylindrical secondary cell (1) of claim 7, wherein the first breakable portion (10) is aligned with the one or more apertures (12a-c).

11. The cylindrical secondary cell (1) of claim 1, wherein the second end side (3b) comprises a second breakable portion (18) configured to provide a second opening (19) in the second end side (3b) if the pressure inside the cylindrical housing (2) reaches a second threshold value.

12. The cylindrical secondary cell (1) of claim 11, wherein the first and second thresholds are different.

13. The cylindrical secondary cell (1) of claim 11, further comprising:
a second current collecting plate (6b) arranged at a second end (2b) of the cylindrical housing (2), and
wherein:
the second terminal (4b) is arranged in electrical contact with the second current collecting plate (6b) via the cylindrical housing (2).

14. The cylindrical secondary cell (1) of claim 1, wherein the opening (11, 19) is in fluid communication with an interior of the cylindrical housing (2) such that gas is able to flow out of the cylindrical housing (2) via the opening (11, 19).

15. The cylindrical secondary cell (1) of claim 1, wherein the breakable portion (10, 18) is a perforated or scored/notched portion of the housing (2) or a portion of the housing (2) having a reduced thickness.

16. The cylindrical secondary cell (1) of claim 1, wherein the breakable portion (10, 18) is annular in shape.

17. The cylindrical secondary cell (1) of claim 1, wherein the breakable portion (10, 18) comprises a plurality of breakable portions each configured to provide respective openings (11, 19).

18. The cylindrical secondary cell (1) of claim 17, wherein each of the plurality of breakable portions (10, 18) has the same form.
